(19) United States
(12) Patent Application Publication
(10) Pub. No.: US 2015/0205908 A1
(43) Pub. Date: Jul. 23, 2015

(54) VERIFICATION METHOD AND VERIFICATION APPARATUS

(71) Applicant: FUJITSU SEMICONDUCTOR LIMITED, Yokohama-shi (JP)

(72) Inventor: Yoshitoshi IWAKI, Akiruno (JP)

(21) Appl. No.: 14/592,597

(22) Filed: Jan. 8, 2015

(30) Foreign Application Priority Data
Jan. 20, 2014 (JP) 2014-007367

(51) Int. Cl. G06F 17/50

(52) U.S. Cl. CPC G06F 17/5081; G06F 17/5045

(57) ABSTRACT

A verification apparatus detects a first delay circuit connected to an output side of a second isolator in a first netlist including first and second isolators, in which the first isolator is inserted into a first path between first and second power domains under first rule, and the second isolator is inserted into a second path between the first and third power domains under second rule. To verify whether the first and second isolators are inserted under the first and second rules respectively, the verification apparatus searches a second netlist generated by performing an optimization step including delay adjustment on the first netlist for a connection destination of the first power domain, and if the connection destination is not the first delay circuit, continues searching, and detects the second power domain, to thereby specify the first path at the time of the first rule being applied.

### CROSS-REFERENCE TO RELATED APPLICATION

This application is based upon and claims the benefit of priority of the prior Japanese Patent Application No. 2014-007367, filed on Jan. 20, 2014, the entire contents of which are incorporated herein by reference.

### FIELD

The embodiments discussed herein are related to a verification method and a verification apparatus.

### BACKGROUND

In recent years various techniques for a low power consumption design have been used for realizing a reduction in the power consumption of semiconductor integrated circuits.

The division of a power domain into a plurality of power domains is one of the techniques for a low power consumption design. With this technique a power supply of a circuit section not used is turned off. In order to prevent an input value to a power domain on a signal receiving side from becoming indefinite at the time of a power supply of a power domain on a signal transmission side being in an off state, an isolator which fixes a signal value outputted from the power domain on the signal transmission side is inserted into a path between the power domains. The isolator is inserted into a specific path by a layout tool in accordance with a rule (referred to as a power intent) defined in a power format.

After the isolator is inserted, the layout tool performs a floor plan step, a placement and routing step, and an optimization step. A netlist in which these steps are reflected is generated. After that, a verification tool verifies whether or not the isolator is inserted into a path in accordance with the above rule in the netlist generated after the optimization step.

Japanese Laid-open Patent Publication No. 2012-185557

Japanese Laid-open Patent Publication No. 2008-262337

Japanese Laid-open Patent Publication No. 09-74138

However, if a delay circuit (which may be referred to as a repeater) is added to a path in the optimization step, it is impossible at verification time to specify a rule applied for inserting an isolator into a path. As a result, a verification error may occur. In that case, for example, a user carries out work visually at a portion at which the verification error has occurred. This requires time.

### SUMMARY

According to an aspect, there is provided a verification method including detecting, by a processor, a first delay circuit connected to an output side of an isolator in a first netlist including the isolator which is inserted into a path between a first power domain and a second power domain in accordance with a rule and which fixes a signal value outputted from the first power domain, searching, by the processor, a second netlist generated by performing an optimization step including a delay adjustment on the first netlist for a connection destination of the first power domain at the time of verifying whether or not the isolator is inserted in accordance with the rule, and specifying, by the processor, the path at the time of the rule being applied by continuing, at the time of the connection destination being a second delay circuit other than the first delay circuit, searching and detecting the second power domain without recognizing the second delay circuit as the connection destination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates examples of a verification method and a verification apparatus according to a first embodiment;

FIG. 2 illustrates an example of a verification apparatus (design apparatus) according to a second embodiment;

FIG. 3 illustrates the flow of an example of a design method;

FIG. 4 illustrates an example of a circuit before isolator insertion;

FIG. 5 illustrates an example of an isolator insertion rule;

FIG. 6 illustrates an example of a circuit after isolator insertion;

FIG. 7 illustrates an example of a circuit after repeater addition;

FIG. 8 is a flow chart of an example of a verification process performed on a netlist generated after an optimization step;

FIG. 9 is a flow chart of an example of an existing repeater detection and recognition table creation step (part 1);

FIG. 10 is a flow chart of an example of an existing repeater detection and recognition table creation step (part 2);

FIG. 11 illustrates an example of a recognition table;

FIG. 12 is a flow chart of an example of a verification process in which an added repeater is ignored (part 1); and

FIG. 13 is a flow chart of an example of a verification process in which an added repeater is ignored (part 2).

### DESCRIPTION OF EMBODIMENTS

Embodiments will now be described with reference to the accompanying drawings, wherein like reference numerals refer to like elements throughout.

### First Embodiment

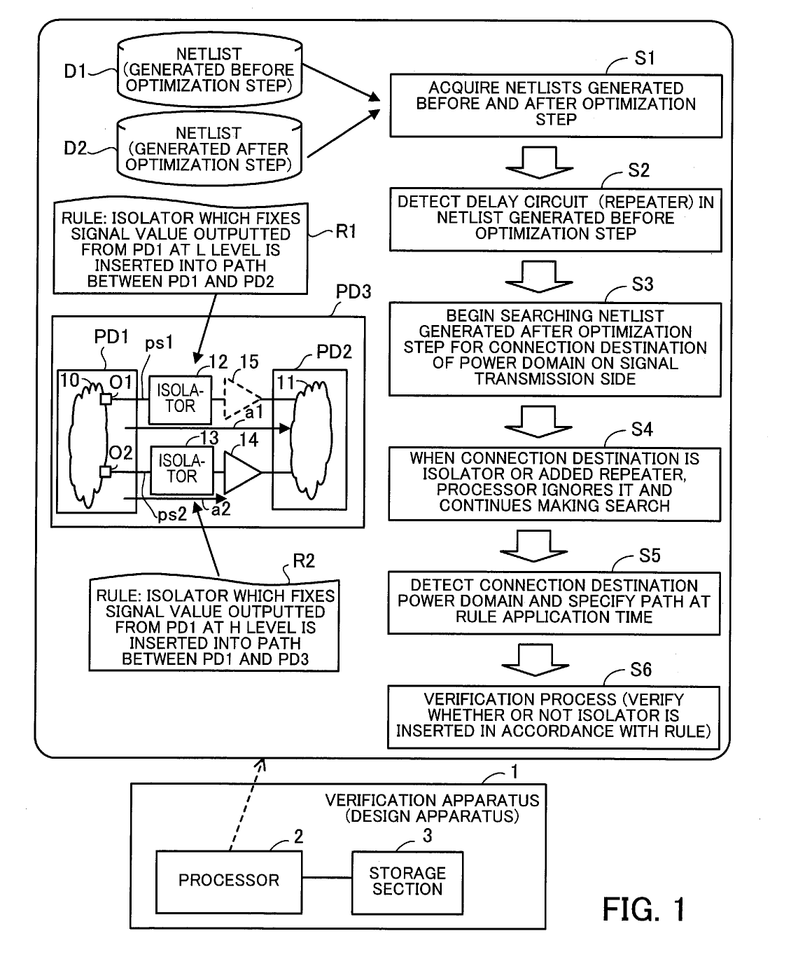

FIG. 1 illustrates examples of a verification method and a verification apparatus according to a first embodiment.

A verification apparatus 1 includes a processor 2 and a storage section 3.

The processor 2 performs a verification process on the basis of data and a program stored in the storage section 3.

The storage section 3 stores a program executed by the processor 2 and various pieces of data. For example, the storage section 3 stores netlists D1 and D2 generated in a layout process performed before a verification process described later and a rule (power intent) for inserting an isolator.

Design processes, such as the layout process, may be performed by another apparatus. However, the verification apparatus 1 may perform the design processes. In that case, the verification apparatus 1 is also referred to as a design apparatus.

The netlist D1 is generated before an optimization step in the layout process and the netlist D2 is generated after the optimization step in the layout process. For example, circuits including power domains PD1, PD2, and PD3 illustrated in FIG. 1 are defined in the netlists D1 and D2.

The power domains PD1 and PD2 to which logic circuit sections 10 and 11, respectively, belong are connected by a path ps1. An isolator 12 which fixes a signal value outputted from the power domain PD1 (value of an output signal outputted from an output terminal O1 of the logic circuit section 10) at a L (Low) level in accordance with a rule R1 is inserted into the path ps1. In the example of FIG. 1, the isolator 12 is arranged so that it will belong to the power domain PD3.

Furthermore, the power domain PD1 and the power domain PD3 to which a delay circuit (hereinafter referred to as a repeater) 14 belongs are connected by a path ps2. An isolator 13 is inserted between the power domain PD1 and the repeater 14 on the path ps2 in accordance with a rule R2. The isolator 13 fixes a signal value outputted from the power domain PD1 (potential level of an output signal outputted from an output terminal O2 of the logic circuit section 10) at a H (High) level. In the example of FIG. 1, the isolator 13 is arranged so that it will belong to the power domain PD3.

A repeater 15 which is connected to the path ps1 and which belongs to the power domain PD3 is added in the optimization step for timing adjustment or the like. The repeater 15 is not defined in the netlist D1 and is defined in the netlist D2.

With the verification method according to the first embodiment it is assumed that the netlists D1 and D2 which are generated in the layout process and in which the above circuits are defined are used.

An example of the verification method according to the first embodiment will now be described.

First the processor 2 acquires the netlists D1 and D2 stored in, for example, the storage section 3 (step S1) and detects a repeater in the netlist D1 (step S2). In step S2, the processor 2 makes a search, for example, from output terminals of the isolators 12 and 13 to a signal receiving side. In the netlist D1, a repeater is not connected to an output side of the isolator 12 and the repeater 14 is connected to an output side of the isolator 13. Accordingly, the repeater 14 is detected in step S2. The detected repeater 14 is stored in, for example, the storage section 3.

After that, the processor 2 verifies in the netlist D2 generated after the optimization step whether or not an isolator is inserted in accordance with the rule R1 or R2. Accordingly, first the processor 2 begins making a search for a connection destination of a power domain on the signal transmission side (in the example of FIG. 1, connection destinations of the output terminals O1 and O2 of the logic circuit section 10 which belongs to the power domain PD1) (step S3).

When a connection destination is an isolator or a repeater (that is to say, a repeater added in the optimization step) other than the repeater 14 detected in step S2, the processor 2 does not recognize it as a connection destination, ignores it, and continues making a search (step S4).

In FIG. 1, each of arrows a1 and a2 indicates a search direction. When a search for connection destinations of the output terminals O1 and O2 of the logic circuit section 10 which belongs to the power domain PD1 is made in the example of FIG. 1, the isolators 12 and 13 and the added repeater 15 are ignored.

The processor 2 then detects a power domain, which is a connection destination, by making a search, and specifies a path at rule application time (step S5). In the example of FIG. 1, a connection destination of the output terminal O1 is the logic circuit section 11, so a connection destination power domain of the output terminal O1 is the power domain PD2 to which the logic circuit section 11 belongs. Furthermore, a connection destination of the output terminal O2 is the repeater 14, so a connection destination power domain of the output terminal O2 is the power domain PD3 to which the repeater 14 belongs.

As a result, the path ps1 between the power domain PD1 and the power domain PD2 and the path ps2 between the power domain PD1 and the power domain PD3 are specified.

The processor 2 then verifies whether or not an isolator is inserted into the path specified in step S5 in accordance with a rule (step S6). For example, the processor 2 reads out the rule R1 or R2 from the storage section 3 for performing step S6.

A path between the power domain PD1 and the power domain PD2 defined by the rule R1 is specified as the path ps1 in step S5. Therefore, whether or not the isolator 12 inserted into the path ps1 is an isolator which fixes a signal value outputted from the power domain PD1 at a L level in accordance with the rule R1 is verified in step S6.

On the other hand, a path between the power domain PD1 and the power domain PD3 defined by the rule R2 is specified as the path ps2 in step S5. Therefore, whether or not the isolator 13 inserted into the path ps2 is an isolator which fixes a signal value outputted from the power domain PD1 at a H level in accordance with the rule R2 is verified.

As has been described, with the verification method according to the first embodiment a path at rule application time is specified in the above way when whether or not an isolator is inserted in accordance with a rule is verified in a netlist generated after the optimization step. Therefore, even if the repeater 15 which belongs to the power domain PD3 is added, as illustrated in FIG. 1, to the path ps1 between the power domain PD1 and the power domain PD2 in the optimization step, a path between the power domain PD1 and the power domain PD3 which is not a path at rule application time is not specified.

This prevents a situation in which which rule is applied to inserting an isolator to a path specified at verification time is not known. As a result, a verification error caused by applying an erroneous rule is avoided.

Assuming that the processor 2 does not ignore the repeater 15 added in the optimization step but recognizes it as a connection destination of the output terminal O1 in step S4, the path ps1 may be recognized as a path which connects the power domain PD1 and the power domain PD3. As a result, the rule R2 may be applied to the path ps1 to perform verification. In that case, an isolator described in the rule R2 is an isolator which fixes a signal value outputted from the power domain PD1 at a H level. Accordingly, even if an isolator 12 which fixes a signal value outputted from the power domain PD1 at a L level is correctly inserted into the path ps1, a verification error occurs because of the difference in isolator type. In that case, for example, a user carries out work visually at a portion at which the verification error has occurred. This requires time. As illustrated in FIG. 1, the isolator 12 inserted into the path ps1 between the power domain PD1 and the power domain PD2 and the repeater 15 added to the path ps1 belong to the power domain PD3 other than the above power domain PD1 and power domain PD2. In such a case, the above problem may arise. As stated above, however, with the verification method according to the first embodiment this problem does not arise.

A flow of the verification method illustrated in FIG. 1 is not limited to the above flow. For example, a netlist generated after the optimization step may be acquired after step S2.

Furthermore, circuit sections which belong to the power domain PD1 and the power domain PD2 are not limited to logic circuit sections. Memories or the like may belong to the power domain PD1 and the power domain PD2.

### Second Embodiment

Examples of a verification method, a design method, and a verification apparatus (design apparatus) according to a second embodiment will now be described.

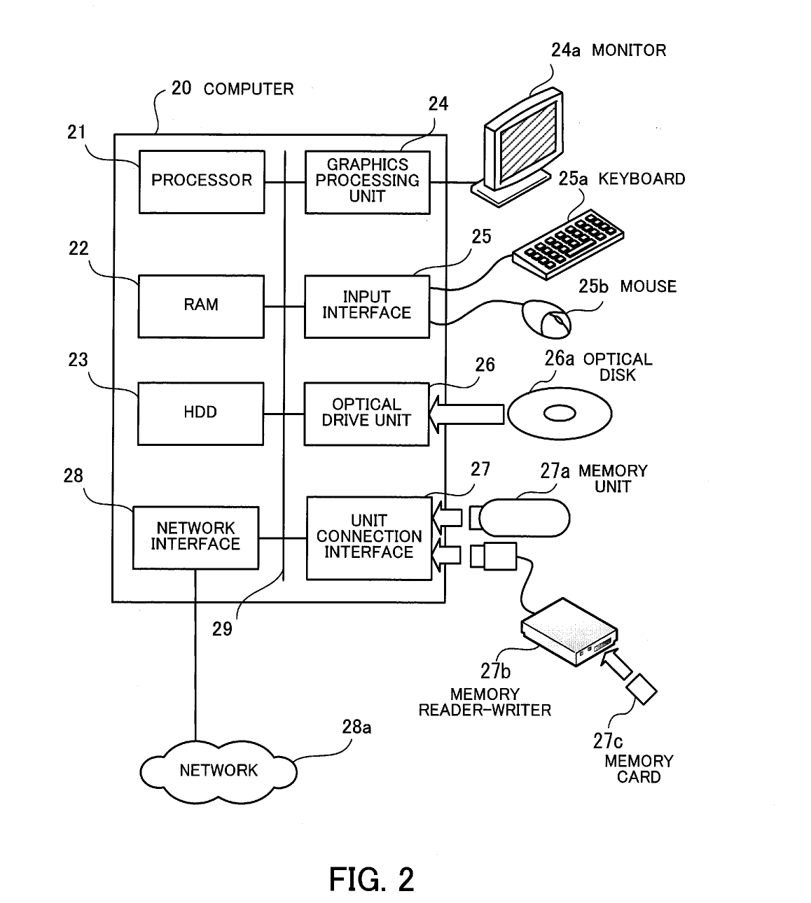

FIG. 2 illustrates an example of a verification apparatus (design apparatus) according to a second embodiment.

A verification apparatus is, for example, a computer 20 illustrated in FIG. 2 and the whole of the computer 20 is controlled by a processor 21. A RAM (Random Access Memory) 22 and a plurality of peripheral units are connected to the processor 21 via a bus 29. The processor 21 may be a multiprocessor. The processor 21 is a CPU (Central Processing Unit), a MPU (Micro Processing Unit), a DSP (Digital Signal Processor), an ASIC (Application Specific Integrated Circuit), a PLD (Programmable Logic Device), or the like. Furthermore, the processor 21 may be a combination of two or more of a CPU, a MPU, a DSP, an ASIC, and a PLD.

The RAM 22 is used as main storage of the computer 20. The RAM 22 temporarily stores at least a part of an OS (Operating System) program or an application program executed by the processor 21. In addition, the RAM stores various pieces of data which the processor 21 needs to perform a process.

The plurality of peripheral units connected to the bus 29 are a HDD (Hard Disk Drive) 23, a graphics processing unit 24, an input interface 25, an optical drive unit 26, a unit connection interface 27, and a network interface 28.

The HDD 23 magnetically writes data to and reads out data from a built-in disk. The HDD 23 is used as auxiliary storage of the computer 20. The HDD 23 stores the OS program, application programs, and various pieces of data. A semiconductor memory, such as a flash memory, may be used as auxiliary storage.

A monitor 24a is connected to the graphics processing unit 24. The graphics processing unit 24 displays an image on a screen of the monitor 24a in accordance with an instruction from the processor 21. The monitor 24a is a display using a CRT (Cathode Ray Tube), a liquid crystal display, or the like.

A keyboard 25a and a mouse 25b are connected to the input interface 25. The input interface 25 transmits to the processor 21 a signal transmitted from the keyboard 25a or the mouse 25b. The mouse 25b is an example of a pointing device and another pointing device, such as a touch panel, a tablet, a touch pad, or a track ball, may be used.

The optical drive unit 26 reads data recorded on an optical disk 26a by the use of a laser beam or the like. The optical disk 26a is a portable record medium on which recorded data can be read by the reflection of light. The optical disk 26a is a DVD (Digital Versatile Disc), a DVD-RAM, a CD-ROM (Compact Disc Read Only Memory), a CD-R(Recordable)/RW(ReWritable), or the like.

The unit connection interface 27 is a communication interface used for connecting peripheral units to the computer 20. For example, a memory unit 27a and a memory reader-writer 27b are connected to the unit connection interface 27. The memory unit 27a is a record medium having the function of communicating with the unit connection interface 27. The memory reader-writer 27b is a unit which writes data to or reads out data from a memory card 27c. The memory card 27c is a card-type record medium.

The network interface 28 is connected to a network 28a. The network interface 28 transmits data to or receives data from another computer or a communication apparatus via the network 28a.

By adopting the above hardware configuration, the processing functions in the second embodiment are realized. The verification apparatus 1 according to the first embodiment illustrated in FIG. 1 is also realized by adopting the same hardware that makes up the computer 20 illustrated in FIG. 2.

The computer 20 realizes the processing functions in the second embodiment by executing a program recorded in, for example, a computer-readable record medium. The program in which the contents of a process that is to be performed by the computer 20 are described is recorded in various record media. For example, the program which is to be executed by the computer 20 is stored in the HDD 23. The processor 21 loads at least a part of the program stored in the HDD 23 into the RAM 22 and executes it. Furthermore, the program which is to be executed by the computer 20 may be recorded on a portable record medium, such as the optical disk 26a, the memory unit 27a, or the memory card 27c. The program recorded on a portable record medium is installed in the HDD 23 and then is executed, under the control of, for example, the processor 21. In addition, the processor 21 may read out the program directly from a portable record medium and execute it.

(Example of Design Method)

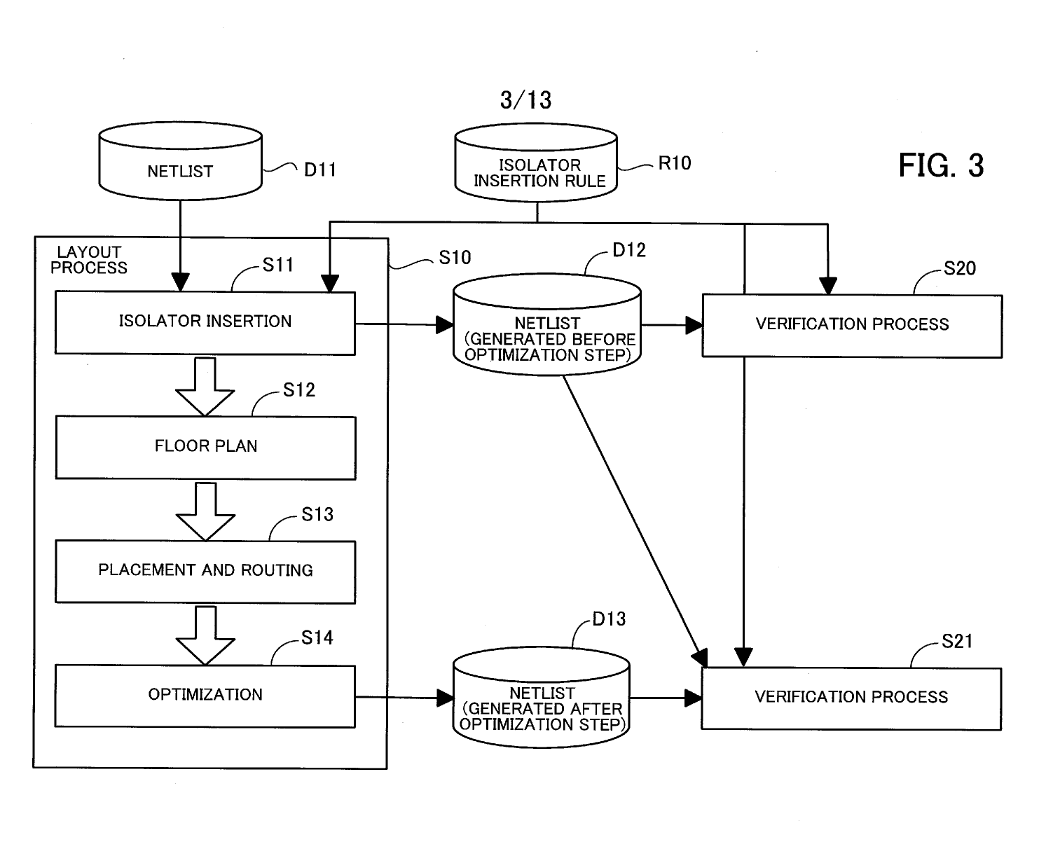

FIG. 3 illustrates the flow of an example of a design method.

Description will now be given on the assumption that the computer 20 illustrated in FIG. 2 can perform each step illustrated in FIG. 3. However, a computer which performs a layout process in step S10 may be different from a computer which performs verification processes in steps S20 and S21. First the layout process will be described.

(Layout Process)

Isolator insertion (step S11), a floor plan (step S12), placement and routing (step S13) and optimization (step S14) are performed in the layout process (step S10).

In the isolator insertion step, the processor 21 reads out a netlist D11 and an isolator insertion rule R10 stored in advance in, for example, the HDD 23. An isolator is then inserted in accordance with the isolator insertion rule R10 into a path between power domains included in a circuit indicated in the netlist D11.

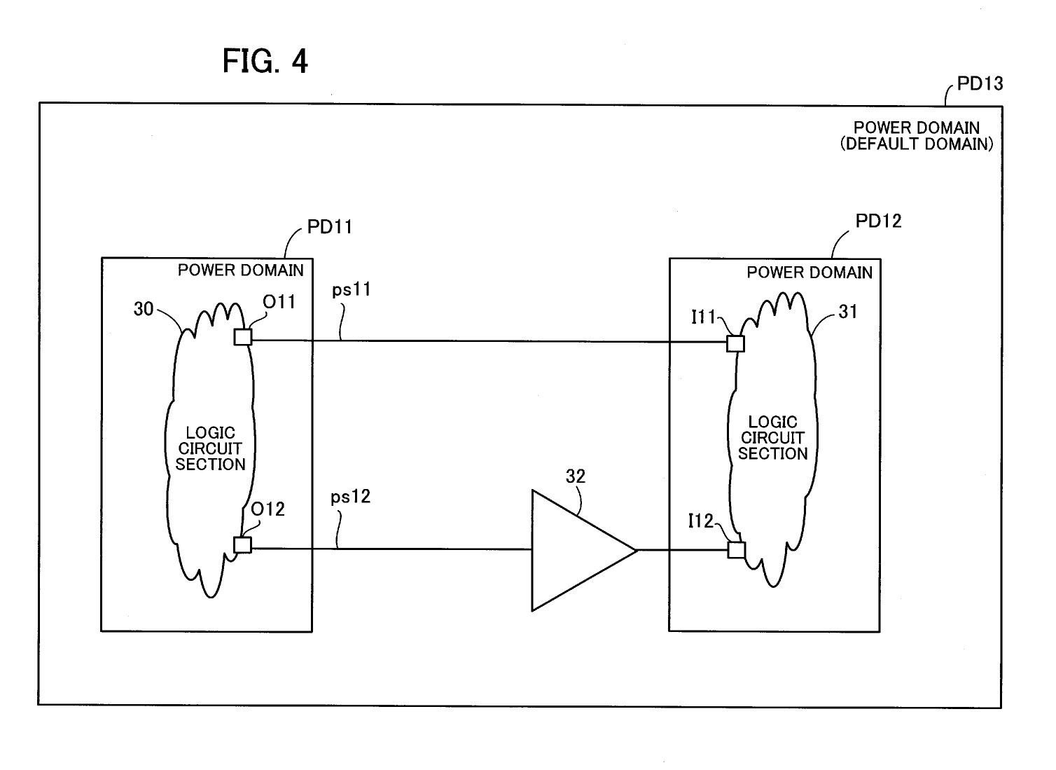

FIG. 4 illustrates an example of a circuit before isolator insertion.

A circuit illustrated in FIG. 4 includes three power domains PD11, PD12, and PD13. The power domains PD11 and PD12 are arranged in the power domain PD13. In the following description it is assumed that the power domain PD13 is defined as a default domain.

Logic circuit sections 30 and 31 belong to the power domains PD11 and PD12 respectively. A repeater 32 belongs to the power domain PD13. An output terminal O11 of the logic circuit section 30 which belongs to the power domain PD11 is connected via a path ps11 to an input terminal I11 of the logic circuit section 31 which belongs to the power domain PD12. An output terminal O12 of the logic circuit section 30 is connected via a path ps12 to an input terminal of the repeater 32 which belongs to the power domain PD13. Furthermore, an output terminal of the repeater 32 is connected to an input terminal 112 of the logic circuit section 31.

Circuit sections which belong to the power domain PD1 and the power domain PD2 are not limited to logic circuit sections. Memories or the like may belong to the power domain PD1 and the power domain PD2.

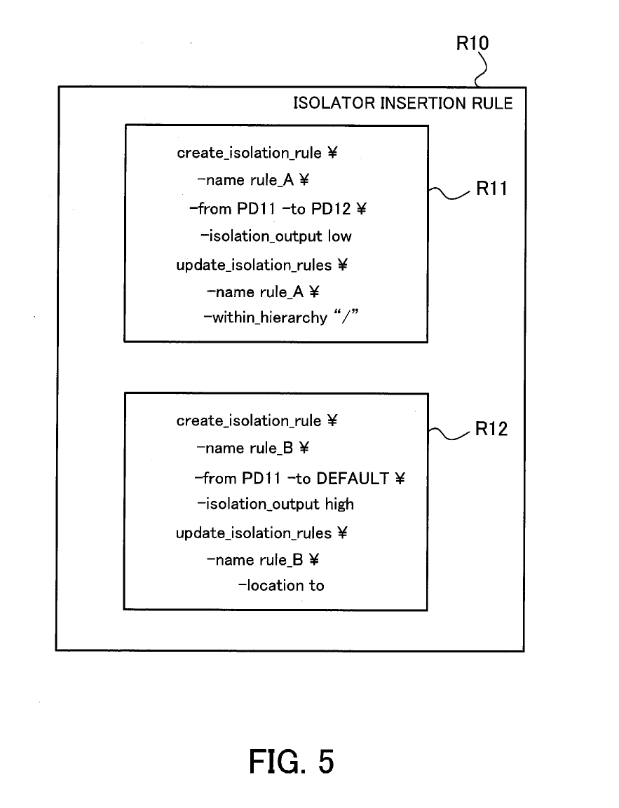

FIG. 5 illustrates an example of an isolator insertion rule.

An isolator insertion rule R10 includes rules R11 and R12. The rules R11 and R12 are power intents defined in a power format. A power format is the Common Power Format (CPF), the Unified Power Format (UPF), or the like.

The names of the rules R11 and R12 are defined in the second lines of the rules R11 and R12 respectively. In the example of FIG. 5, the name of the rule R11 is defined as “rule_A” and the name of the rule R12 is defined as “rule_B”.

Power domains between which an isolator is inserted are specified in the third line of each of the rules R11 and R12. The rule R11 specifies that an isolator is inserted between power domains PD11 and PD12. The rule R12 specifies that an isolator is inserted between the power domain PD11 and a default domain (power domain PD13 in FIG. 4).

A potential level of a signal outputted from an isolator, that is to say, whether a signal outputted from an isolator is at an H or L level is specified in the fourth line of each of the rules R11 and R12. The rule R11 specifies that an isolator outputs a signal whose potential level is an L level. The rule R12 specifies that an isolator outputs a signal whose potential level is an H level.

In the example of FIG. 5, contents updated for specifying a power domain to which an isolator belongs are added to the fifth line of each of the rules R11 and R12. The names of the rules R11 and R12 are defined again in the sixth lines of the rules R11 and R12 respectively.

In addition, a power domain to which an isolator is made to belong is specified in the seventh line of each of the rules R11 and R12. The rule R11 specifies “-within_hierarchy “/”” and specifies that an isolator is made to belong to the top layer, that is to say, to the default domain (power domain PD13 in FIG. 4). The rule R12 specifies “-location to” and specifies that an isolator is made to belong to the default domain specified in the third line.

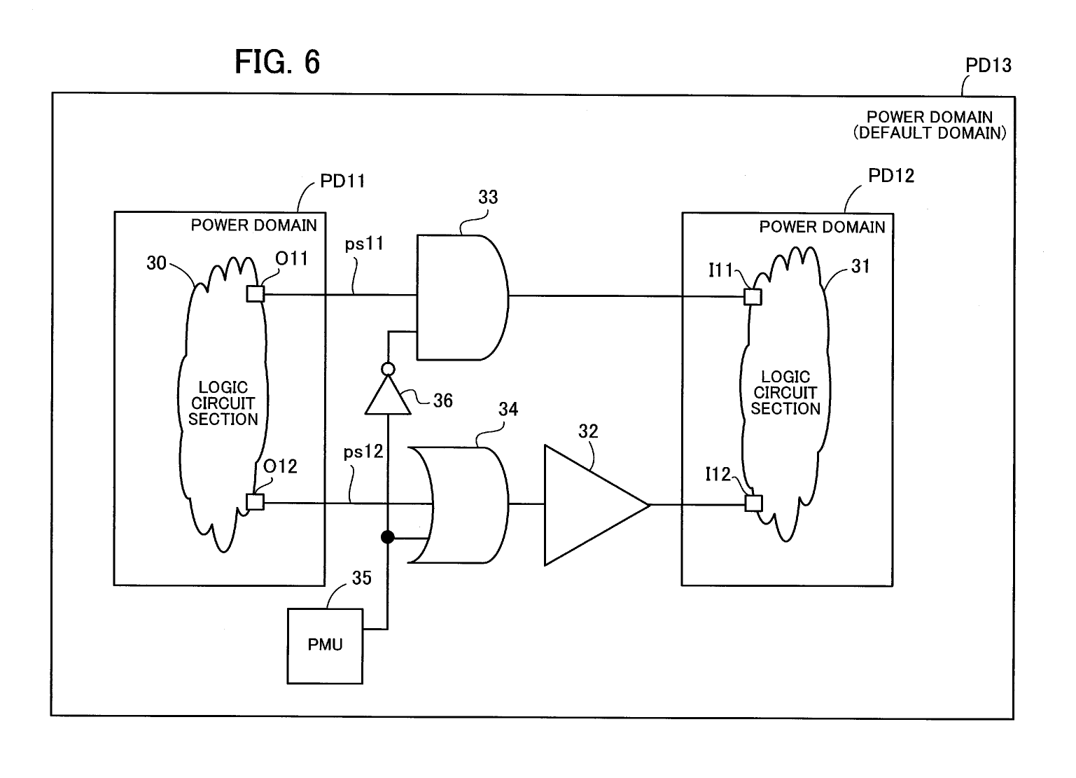

FIG. 6 illustrates an example of a circuit after isolator insertion.

Components which are the same as those illustrated in FIG. 4 are marked with the same numerals. Isolators 33 and 34 are inserted into the paths ps11 and ps12, respectively, in a circuit illustrated in FIG. 6 in accordance with the isolator insertion rule R10 illustrated in FIG. 5. Furthermore, FIG. 6 illustrates a PMU (Power Management Unit) 35 which controls the isolators 33 and 34 and an inverter 36 which inverts the potential level of a control signal outputted from the PMU 35.

In the example of FIG. 6, the isolator 33 inserted into the path ps11 is an AND circuit. One input terminal of the isolator 33 is connected to the output terminal O11 of the logic circuit section 30 which belongs to the power domain PD11. The other input terminal of the isolator 33 is connected to an output terminal of the inverter 36. Furthermore, an output terminal of the isolator 33 is connected to the input terminal Ill of the logic circuit section 31 which belongs to the power domain PD12.

In the example of FIG. 6, the isolator 34 inserted into the path ps12 is an OR circuit. One input terminal of the isolator 34 is connected to the output terminal O12 of the logic circuit section 30 which belongs to the power domain PD11. The other input terminal of the isolator 34 is connected to the PMU 35. Furthermore, an output terminal of the isolator 34 is connected to the input terminal of the repeater 32.

When the power domain PD11 is in an on state in the above circuit, the PMU 35 makes the potential level of a control signal an L level. At this time each of the isolators 33 and 34 does not fix a signal value outputted from the power domain PD11 but outputs a signal corresponding to a signal value outputted from the power domain PD11. That is to say, a signal outputted from the output terminal O11 of the logic circuit section 30 which belongs to the power domain PD11 is inputted via the isolator 33 to the input terminal Ill of the logic circuit section 31 which belongs to the power domain PD12.

Furthermore, a signal outputted from the output terminal O12 of the logic circuit section 30 is inputted via the isolator 34 to the input terminal of the repeater 32.

On the other hand, when the power domain PD11 is in an off state, the PMU 35 makes the potential level of a control signal an H level. At this time each of the isolators 33 and 34 fixes a signal value outputted from the power domain PD11. In the case of the isolators 33 and illustrated in FIG. 6, the isolators 33 and 34 fix signal values outputted at L and H levels respectively. This prevents an indefinite signal from being inputted to the logic circuit section 31 which belongs to the power domain PD12 or the repeater 32 which belongs to the power domain PD13 at the time of the power domain PD11 being in an off state.

The isolator 33 is not limited to an AND circuit and 34 and an isolator 34 is not limited to an OR circuit. Circuits which output signals whose potential levels are in accordance with the rules R11 and R12 may be used as the isolators 33 and 34 respectively.

As stated above, the processor 21 generates a netlist D12 on the basis of the circuit in which the isolators 33 and 34 are inserted into the paths ps11 and ps12 respectively.

In the layout process, as illustrated in FIG. 3, the floor plan (step S12), the placement and routing (step S13) and the optimization (step S14) are performed after the isolator insertion.

In the optimization step, optimization is performed in order to satisfy a timing constraint. At this time a repeater may be added for delay adjustment.

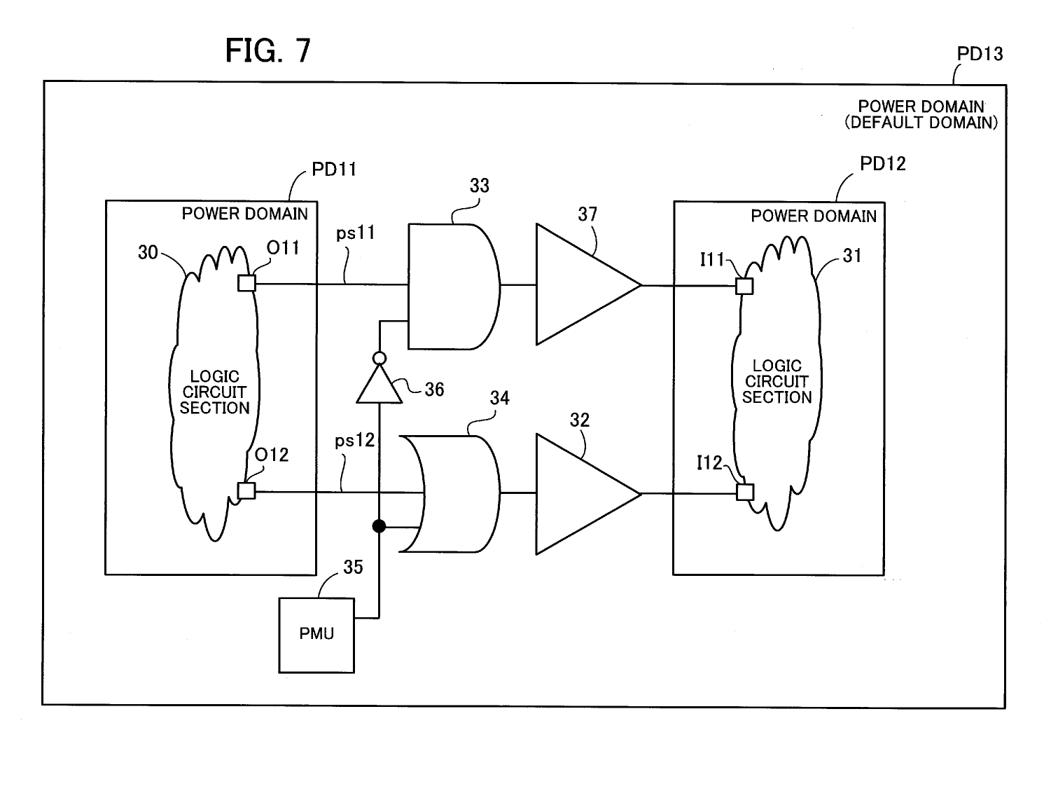

FIG. 7 illustrates an example of a circuit after repeater addition.

Components which are the same as those illustrated in FIG. 6 are marked with the same numerals. In a circuit illustrated in FIG. 7, a repeater 37 is added between the output terminal of the isolator 33 and the input terminal Ill of the logic circuit section 31 on the path ps11. In the example of FIG. 7, the repeater 37 is illustrated as a buffer circuit. However, the repeater 37 is not limited to a buffer circuit. For example, an even number of inverters connected in series may be used as the repeater 37.

The processor 21 generates a netlist D13 on the basis of a circuit on which an optimization step like that described above has been performed.

A verification process will now be described.

(Verification Process)

As illustrated in FIG. 3, there are a verification process performed on the netlist D12 generated before the optimization step (verification process in step S20) and a verification process performed on the netlist D13 generated after the optimization step (verification process in step S21).

Whether or not an isolator is inserted correctly on the basis of the isolator insertion rule R10 in the netlist D12 is verified in the verification process in step S20.

Whether or not an isolator is also inserted correctly on the basis of the isolator insertion rule R10 in the netlist D13 generated after the optimization step is verified in the verification process in step S21.

An example of the verification process in step S21 will now be described.

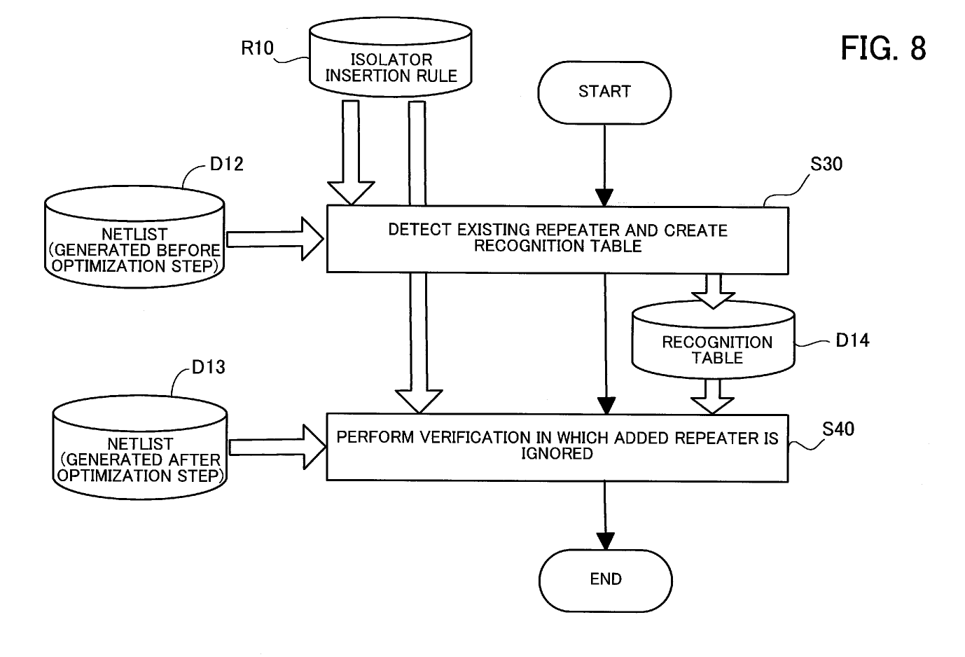

FIG. 8 is a flow chart of an example of the verification process performed on the netlist generated after the optimization step.

In the verification process performed on the netlist D13 generated after the optimization step, detection of an existing repeater and creation of a recognition table D14 (step S30) and verification in which an added repeater is ignored (step S40) are performed.

In step S30, the isolator insertion rule R10 is referred to, an existing repeater connected to an output side of an isolator is detected in the netlist D12 generated before the optimization step, and the recognition table D14 for managing the detected repeater is created.

In step S40, the recognition table D14 and the isolator insertion rule R10 are referred to and optimization step is ignored is performed on the netlist D13 generated after the optimization step.

An example of each of steps S30 and S40 will now be described.

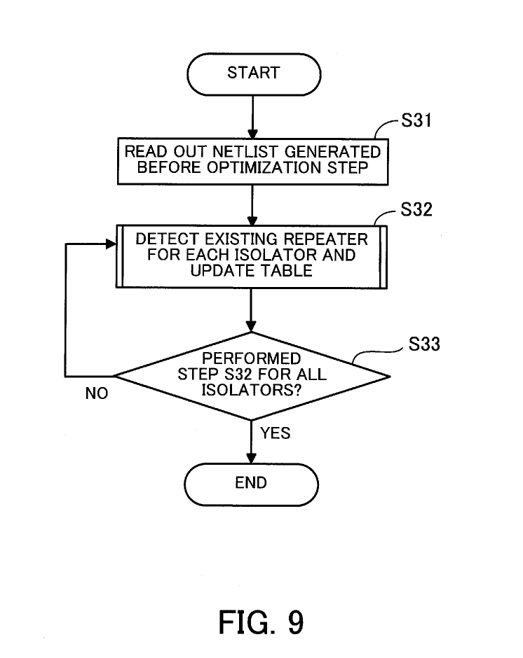

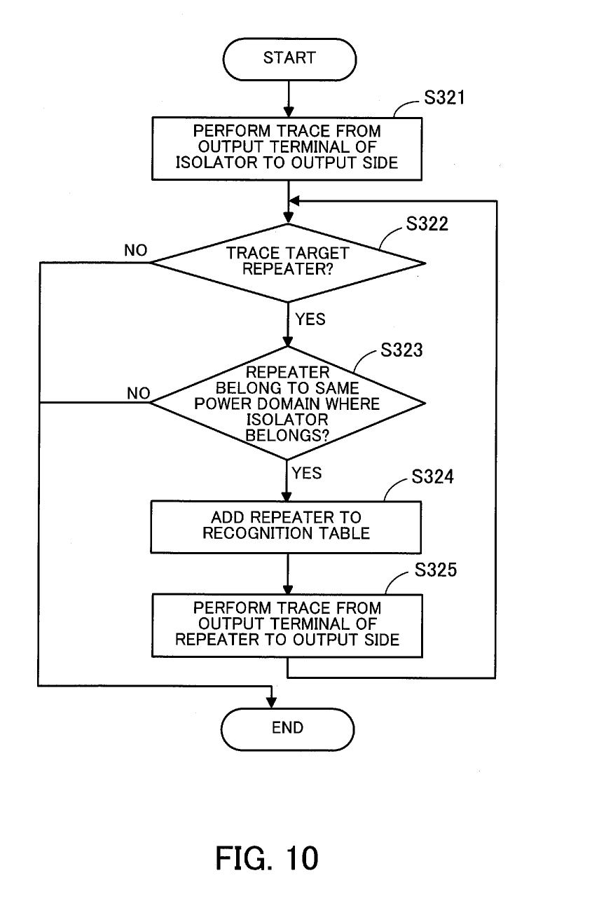

FIGS. 9 and 10 are flow charts of an example of an existing repeater detection and recognition table creation step.

First the processor 21 reads out the netlist D12 which is generated before the optimization step and which is stored in, for example, the HDD 23 (step S31). The processor 21 then reads out the isolator insertion rule R10 stored in, for example, the HDD 23, detects an existing repeater for each isolator, and updates a table (step S32). The processor 21 determines whether or not it has performed step S32 for all isolators (step S33). If there is an isolator for which the processor 21 has not performed step S32, then the processor 21 repeats steps S32 and S33. If the processor 21 has performed step S32 for all the isolators, then the processor 21 ends the existing repeater detection and recognition table creation step.

FIG. 10 illustrates an example of step S32.

First the processor 21 performs trace from an output terminal of an isolator to an output side in the netlist D12 generated before the optimization step (step S321). The processor 21 determines whether or not a trace target (connection destination of the output terminal) is a repeater (step S322). If a trace target is not a repeater, then step S32 ends. If a trace target is a repeater, then the processor 21 determines whether or not the repeater belongs to the same power domain where the isolator belongs (step S323). The netlist D12 includes information indicative of which power domain a cell, such as a repeater, belongs to, so the processor 21 can perform step S323.

If the repeater does not belong to the same power domain where the isolator belongs, then the processor 21 ends step S32. If the repeater belongs to the same power domain where the isolator belongs, then the processor 21 adds the repeater to the recognition table D14 (step S324). By performing trace from the output terminal of the isolator, a search path (trace path) is shortened and a processing load is reduced.

After that, the processor 21 performs trace further from an output terminal of the repeater to the output side (step S325) and repeats steps S322 through S325. The reason for this is that repeaters may be connected in succession.

For example, it is assumed that each step illustrated in FIGS. 9 and 10 is performed on the netlist D12 in which the circuit illustrated in FIG. 6 is indicated. A repeater is not connected to the output terminal of the isolator 33, so no repeater is detected. However, the repeater 32 which belongs to the same power domain PD13 where the isolator 34 belongs is connected to the output terminal of the isolator 34, so the repeater 32 is added to the recognition table D14 as an existing repeater.

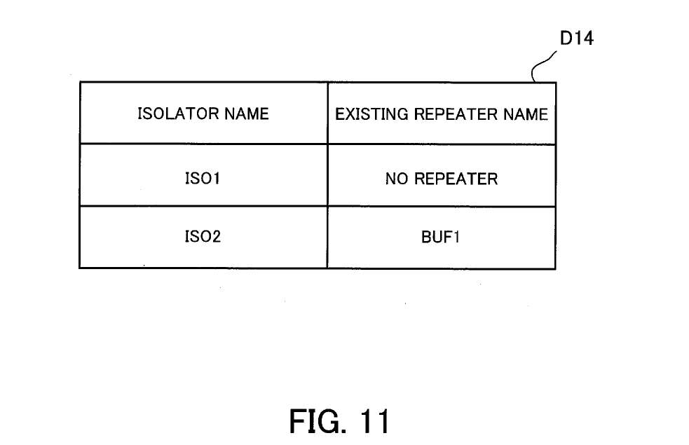

FIG. 11 illustrates an example of the recognition table.

FIG. 11 illustrates an example of the recognition table D14 created in the case of each step illustrated in FIGS. 9 and 10 being performed on the netlist D12 in which the circuit illustrated in FIG. 6 is indicated.

The recognition table D14 includes the names of the isolators 33 and 34 (in the example of FIG. 11, “IS01” and “IS02” respectively) each having the output terminal which is a starting point of trace and the name of an existing repeater detected. As stated above, no repeater is detected when trace is performed from the output terminal of the isolator 33. Accordingly, the name of an existing repeater is not registered. On the other hand, the repeater 32 is detected when trace is performed from the output terminal of the isolator 34. Accordingly, the name of the repeater 32 (in the example of FIG. 11, “BUF1”) is registered.

Step S40 illustrated in FIG. 8 will now be described.

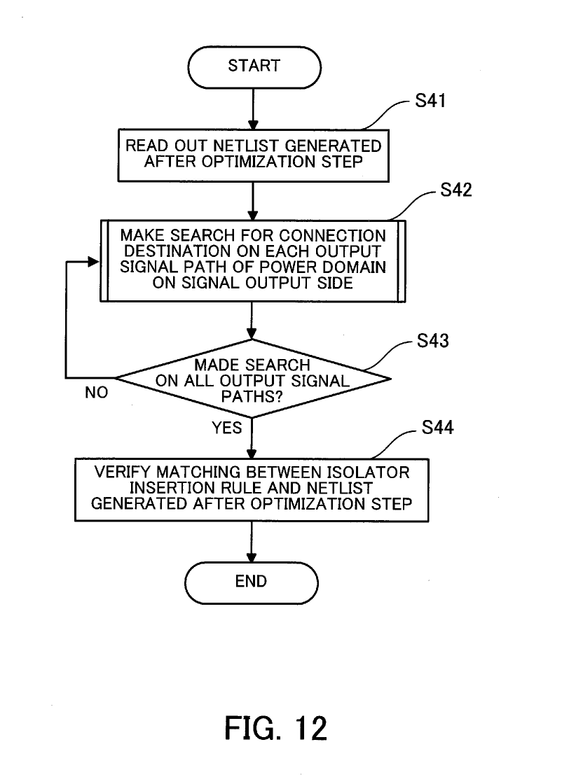

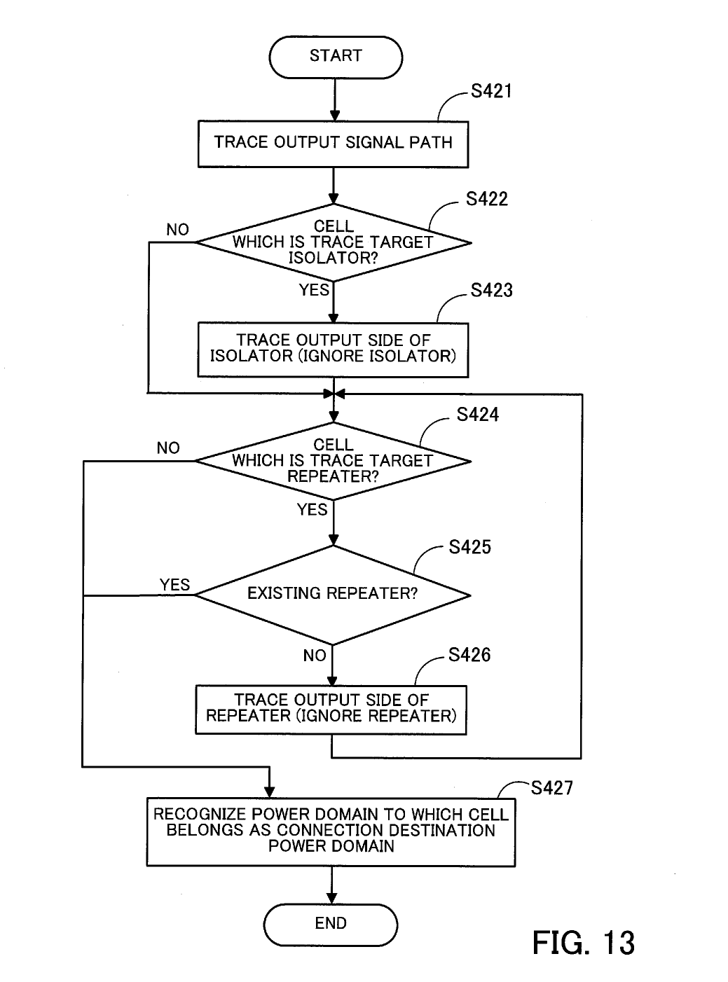

FIGS. 12 and 13 are flow charts of an example of a verification process in which an added repeater is ignored.

First the processor 21 reads out the netlist D13 which is generated after the optimization step and which is stored in, for example, the HDD 23 (step S41). The processor 21 then makes a search for (traces) a connection destination on each output signal path of a power domain on a signal output side in the netlist D13 generated after the optimization step (step S42). The processor 21 determines whether or not it has made a search on all output signal paths (step S43). If the processor 21 has not made a search on all the output signal paths, then the processor 21 repeats steps S42 and S43. If the processor 21 has made a search on all the output signal paths, then the processor 21 verifies matching between the isolator insertion rule R10 and the netlist D13 generated after the optimization step (step S44) and ends the verification process in which an added repeater is ignored.

FIG. 13 illustrates an example of step S42.

First the processor 21 traces an output signal path of the power domain on the signal output side in the netlist D13 generated after the optimization step (step S421). The processor 21 determines whether or not a cell which is a trace target is an isolator (step S422). If the cell which is a trace target is an isolator, then the processor 21 traces an output side of the isolator (ignores the isolator and continues tracing) (step S423).

If the cell which is a trace target is not an isolator or after the processor 21 performs step S423, the processor 21 determines whether or not a cell which is a trace target is a repeater (step S424). If the cell which is a trace target is not a repeater, then the processor 21 performs step S427. If the cell which is a trace target is a repeater, then the processor 21 refers to the recognition table D14 and determines whether or not the repeater is an existing repeater managed by the recognition table D14 (step S425).

If the repeater which is a trace target is an existing repeater, then the processor 21 performs step S427. If the repeater which is a trace target is not an existing repeater, then the processor 21 traces an output side of the repeater (ignores the repeater and continues tracing) (step S426). After the processor 21 performs step S426, the processor 21 repeats steps S424 through S426.

In step S427, the processor 21 recognizes a power domain to which the cell which is a trace target belongs as a power domain which is a connection destination of the power domain on the signal output side. As a result, step S42 ends and step S43 illustrated in FIG. 12 is performed.

For example, it is assumed that each step illustrated in FIGS. 12 and 13 is performed on the netlist D13 in which the circuit illustrated in FIG. 7 is indicated. A search for a connection destination is made on each of the paths ps11 and ps12 which are output signal paths of the power domain PD11.

When the paths ps11 and ps12 are traced, the isolators 33 and 34 are detected. The isolators 33 and 34 are ignored and output sides of the isolators 33 and 34 are traced.

In the example of FIG. 7, the repeaters 37 and are detected as cells, which are trace targets, as a result of tracing the output sides of both the isolators 33 and 34. The repeater 32 is managed by the recognition table D14, so the determination that the repeater 32 is an existing repeater is made in step S425. As a result, the power domain PD13 to which the repeater 32 belongs is recognized as a connection destination power domain in step S427.

On the other hand, the repeater 37 is not managed by the recognition table D14, so the determination that the repeater 37 is not an existing repeater is made in step S425. As a result, the repeater 37 is ignored and an output side of the repeater 37 is traced. Furthermore, a cell (not illustrated) including the input terminal Ill of the logic circuit section 31 is detected as a cell which is a trace target, and the power domain PD12 to which the cell belongs is recognized as a connection destination power domain.

When a connection destination power domain is recognized by the above step, a path at the time of the application of the isolator insertion rule R10 is specified. Accordingly, the occurrence of a verification error caused by applying an erroneous rule to the specified path is prevented in step S44 in which matching verification is performed.

In the above example, for example, the path ps11 between the power domain PD11 and the power domain PD12 is specified. Accordingly, the processor 21 recognizes that it applies the rule R11 of the isolator insertion rule R10 illustrated in FIG. 5. In addition, the path psl2 between the power domain PD11 and the power domain PD13 is specified. Accordingly, the processor 21 recognizes that it applies the rule R12.

As a result, when whether or not the isolators and 34 are correctly inserted in accordance with the rules R11 and R12, respectively, is verified in the netlist D13 generated after the optimization step, the occurrence of a verification error caused by mismatching between the netlists generated before and after the optimization step is prevented. Accordingly, for example, the amount of visual work by a user at a portion at which a verification error has occurred is reduced and the user's loads are reduced.

The flow of each verification method illustrated in FIG. 9, 10, 12, or 13 is not limited to the above flow.

According to the disclosed verification method, design method, verification apparatus, design apparatus, and program, the occurrence of a verification error is prevented.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A verification method comprising:
detecting, by a processor, a first delay circuit connected to an output side of an isolator in a first netlist including the isolator which is inserted into a path between a first power domain and a second power domain in accordance with a rule and which fixes a signal value outputted from the first power domain;
searching, by the processor, a second netlist generated by performing an optimization step including a delay adjustment on the first netlist for a connection destination of the first power domain at the time of verifying whether or not the isolator is inserted in accordance with the rule; and
specifying, by the processor, the path at the time of the rule being applied by continuing, at the time of the connection destination being a second delay circuit other than the first delay circuit, the searching and detecting the second power domain without recognizing the second delay circuit as the connection destination.

2. The verification method according to claim 1, wherein the isolator and the second delay circuit belong to a third power domain different from the first power domain and the second power domain.

3. The verification method according to claim 1, wherein the processor searches the first netlist from an output terminal of the isolator to a signal output side and detects the first delay circuit.

4. A verification apparatus comprising a processor which:
detects a first delay circuit connected to an output side of an isolator in a first netlist including the isolator which is inserted into a path between a first power domain and a second power domain in accordance with a rule and which fixes a signal value outputted from the first power domain;
searches a second netlist generated by performing an optimization step including a delay adjustment on the first netlist for a connection destination of the first power domain at the time of verifying whether or not the isolator is inserted in accordance with the rule; and
specifies the path at the time of the rule being applied by continuing, at the time of the connection destination being a second delay circuit other than the first delay circuit, searching and detecting the second power domain without recognizing the second delay circuit as the connection destination.

5. A computer-readable, non-transitory record medium storing a program which causes a computer to perform a process comprising:
detecting a first delay circuit connected to an output side of an isolator in a first netlist including the isolator which is inserted into a path between a first power domain and a second power domain in accordance with a rule and which fixes a signal value outputted from the first power domain;
searching a second netlist generated by performing an optimization step including a delay adjustment on the first netlist for a connection destination of the first power domain at the time of verifying whether or not the isolator is inserted in accordance with the rule; and
specifying the path at the time of the rule being applied by continuing, at the time of the connection destination being a second delay circuit other than the first delay circuit, searching and detecting the second power domain without recognizing the second delay circuit as the connection destination.
